(19) United States
(12) Patent Application Publication
(10) Pub. No.: US 2007/0233319 A1
(43) Pub. Date: Oct. 4, 2007

(54) SYSTEM AND METHOD FOR RETURNING MOBILE ROBOT TO CHARGING STAND

(75) Inventors: Hyoung-deuk IM, Seoul (KR); Sang-yun KIM, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/690,508

(22) Filed: Mar. 23, 2007

(30) Foreign Application Priority Data
Mar. 29, 2006 (KR) 10-2006-0028596

(51) Int. Cl. G06F 19/00

(52) U.S. Cl. 700/245

(57) ABSTRACT

A system is provided for returning a robot to a charger. In this regard, a charger is configured to provide a plurality of docking guide regions by outputting at least one guide signal superposed with at least one other signal to form a return region. Further, the robot is configured to return to the charger at a return speed by detecting the return region.

### CROSS REFERENCE TO RELATED APPLICATION

The present application is related to Korean Application No. 10-2006-0028596, filed Mar. 29, 2006, the content of which is expressly incorporated herein in its entirety.

### BACKGROUND OF THE INVENTION

1. Field of the Invention

The present invention relates to a mobile robot, and more particularly to a system and a method for returning a mobile robot to a charging stand. In this regard, the mobile robot can be accurately and promptly returned to the charging stand by controlling the direction of a guide signal output from the charging stand. Additionally, the mobile robot may be returned to the charger via a return region (e.g., a high speed return region).

2. Description of the Related Art

A robot has been developed for industrial purposes, e.g., to be used for factory automation or to collect information (i.e., instead of a human being) in a severe environment which a human being cannot endure. The robot engineering field has developed and has recently even been applied to the most advanced space exploration industry. Further, a human friendly home robot has also been developed recently. An example of such a human friendly home robot is a cleaning robot.

The cleaning robot, which is a type of mobile robot, is a device that sucks dust and foreign substances while traveling in a cleaned area such as a house or an office. The cleaning robot includes a traveler including, e.g., right and left wheel motors which move (i.e., allow the robot to travel) the cleaning robot, a plurality of detection sensors for moving (i.e., allowing the robot to travel) the cleaning robot without preventing collision of the cleaning robot with various obstacles in the cleaned area, and a control section controlling the overall device. The cleaning robot may incorporate general functions of a vacuum cleaner for sucking dust and foreign substances.

On the other hand, since the mobile robot performs its duty while moving in a predetermined area by itself, it has an automatic charging function. The automatic charging function is provided for charging an insufficient power source of a battery by returning the mobile robot to the charging stand installed at a predetermined position of the duty performing area if the residual amount of the battery recognized by the mobile robot itself is below a reference value and then restarting the duty of the mobile robot.

According to a method for automatically returning a conventional mobile robot having the aforementioned automatic charging function to a charging stand, the position of the charging stand is determined and the mobile robot returns to the charging stand by attaching an artificial mark to the charging stand and allowing the mobile robot to detect the mark attached to the charging stand through random traveling along a wall surface of a duty performing area.

However, since the mobile robot travels (or moves) at random along the wall surface, the time for returning the mobile robot to the charging stand is different according to the area in which the mobile robot is located. Therefore, according to the conventional method for returning to the mobile robot to the charging stand in the wall surface via a random traveling method, when the time for detecting the artificial mark attached to the charging stand becomes longer, the power source stored in the battery is completely discharged while the mobile robot is returning the charging stand. Thus, the drive of the mobile robot may be stopped prior to reaching the charging stand to recharge.

According to another method, a plurality of infrared ray sensors emitting different signals are installed in a charging stand to classify regions and a mobile robot detects a signal received only in a predetermined area to return the mobile robot to the charging stand.

However, according to the method, since the infrared ray signal emitted from the charging stand forms a guide region in a fan-like shape, the mobile robot should find the accurate position of the charging stand through right and left rotations while the mobile robot is approaching the charging stand and the charging stand return path should be continuously changed until the mobile robot makes mechanical or electrical contact with the charging stand.

### SUMMARY OF THE INVENTION

Accordingly, the present invention has been made to solve the above-mentioned problems occurring in the prior art. In this regard, at least one object of the present invention is to provide a system and a method for returning a mobile robot (or robot) to a charging stand (or charger). More particularly, to provide a system and method which promptly and effectively returns the mobile robot to the charging stand via straight traveling (e.g., along a straight line or path) of the mobile robot in a corresponding region by forming a return region (e.g., a high speed return region) having a predetermined width and a straight proceeding property (e.g., a generally straight path) in an optimal direction in which the mobile robot enters into the charging stand.

It is another object of the present invention to provided a system and a method for returning a mobile robot to a charging stand by providing a guide section to form, e.g., a high speed return guide region via the guide section. In this regard, the guide section may control the direction of a guide signal output from the charging stand.

In a system for returning a mobile robot to a charging stand according to one aspect of the present invention, the mobile robot may be configured to detect a residual amount of a battery (or any other suitable power supply) while traveling (or moving) in a duty performing area and receive a guide signal emitted from the charging stand while traveling at random if/when it is determined that the battery should be charged.

The guide signals emitted from the charging stand may have different frequency bandwidths and are be emitted to different regions. A region in which the guide signals are superposed, e.g., a region corresponding to an optimal straightly traveling path (or a return region) when the mobile robot enters into the charging stand may be formed as a high speed return region having a predetermined width and a straightly proceeding property. Additionally, the guide signals may be infrared ray signals. However, it should be appreciated that any guide signal suitable for guidance may be employed.

According to one aspect of the present invention, the charging stand according to the present invention may have a guide section formed on one side of an infrared ray emitting section which may be configured to output the guide signals in order to regulate a proceeding direction of the infrared ray signal outputted from the infrared ray emitting section. In other words, the guide section on one side of an infrared emitting section which may configured to emit a guide signal, may direct the guide signal such that the guide signal is emitted to one side of the guide section. Further, the guide signal may be widely emitted to the right and left sides so that the infrared ray signal proceeds in a predetermined direction, i.e. the infrared ray signal has the straightly proceeding property.

The infrared ray signal output by the guide section has the straightly proceeding property (e.g., a generally straight path), and thus the region in which two infrared ray signals are superposed has a predetermined width and the straightly proceeding property, thereby forming, for example, the high speed return region.

On the other hand, the mobile robot may detect the guide signals output from the charging stand and determine the current position, and straightly travel in a corresponding region (e.g., either one of a first and second guide region). The mobile robot may then return to the charging stand by detecting the signal of the high speed return region received in a predetermined region which may correspond to the optimal straightly proceeding traveling path (i.e., having a predetermined width and the straightly proceeding property).

Additionally, the mobile robot may include at least one side surface sensor configured to detect a guide signal output form the charging stand and at least one front surface sensor. The side surface sensor may be used to determine the region of the guide signal output from the charging stand. Additionally, the front surface sensor, together with the side surface sensor, may be used to determine the region of the guide signal and whether the mobile robot has entered into the return region (e.g., a high speed return region corresponding to the optimal straightly traveling path). In this regard, the sensors may be used to allow the mobile robot to straightly travel (e.g., along a generally straight line or path) in the high speed return region to dock the mobile robot to the charging stand.

Accordingly, the mobile robot automatically travels until the side surface sensor or the front surface sensor detects the guide signal output from the charging stand. Further, a battery charging signal (or other suitable power supply) may be outputted from the battery detecting circuit (or power supply detecting circuit). In this regard, the robot may determine whether the corresponding signal indicates the high speed return region when the guide signal is detected by either one of the side surface sensor and the front surface sensor. Then, if/when the mobile robot is determined to have entered into the return region, the mobile robot may be rotated so that the front surface sensor faces the direction in which the corresponding signal is transmitted, and the robot may then straightly travel to the charging stand.

If/When the mobile robot makes electrical or mechanical contact with the charging stand while straightly traveling via the front surface sensor, the mobile robot may be docked to the charging stand by utilizing a charging stand docking algorithm to charge the battery.

Therefore, since the mobile robot may straightly travel (e.g., along a generally straight path or line) to the charging stand by providing a transmission direction of the guide signal outputted from the charging stand with the straightly proceeding property through the guide section, the optimal path region for entering the mobile robot to the charging stand may be provided. For example, the return region may effectively return the mobile robot to the charging stand in a shorter time (e.g., at a higher speed along a straight line (or path)).

### BRIEF DESCRIPTION OF THE DRAWINGS

The present invention is further described in the detail description which follows, in reference to the noted plurality of drawings, by way of non-limiting examples of preferred embodiments of the present invention, in which like characters represent like elements throughout the several views of the drawings, and wherein:

FIG. 1 is a view schematically showing a system for returning a mobile robot to a charging stand according to a preferred embodiment of the present invention;

FIG. 2 is a block diagram schematically showing a charging stand according to a preferred embodiment of the present invention;

FIG. 3 is a view schematically showing a guide section according to a preferred embodiment of the present invention;

FIG. 4 is a block diagram schematically showing a cleaning robot which is an example of the mobile robot of FIG. 1; and

FIG. 5 is a flow chart showing a method for returning a mobile robot to a charging stand according to a preferred embodiment of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice

Hereinafter, preferred embodiments of the present invention will be described in detail with reference to the accompanying drawings so that those skilled in the art can easily understand and reproduce the invention.

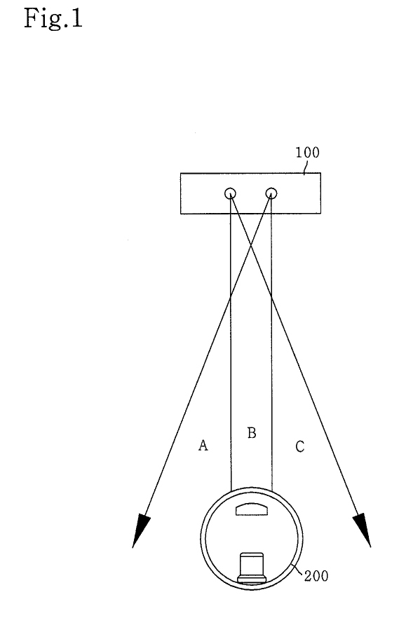

FIG. 1 is a view schematically showing a system for returning a mobile robot to a charging stand (or charger) according to a non-limiting embodiment of the present invention. As shown in the figure, the system for returning a mobile robot to a charging stand according to the present invention may include a charging stand 100 configured to provide a plurality of docking guide regions (e.g., a return region and first and second guide regions) by outputting at least one guide signal and forming a return region (e.g., a high speed return region) in a region in which the guide signal is superposed (e.g., with at least one other signal) by regulating the proceeding direction of the guide signal; and a mobile robot 200 returning to the charging stand 100, e.g., at a high speed by detecting the high speed return region formed by the charging stand 100.

The charging stand 100 charges a battery supplying a power source (or any other power supply) for driving the mobile robot 200. If/When the mobile robot (or robot) 200 determines that it is necessary to charge the mobile robot 200 by detecting the residual amount of the battery while performing a duty, it returns to the charging stand 100 via a charging stand return algorithm. If the charging stand 100 is docked to the mobile robot 200 by a docking algorithm, a power source may be supplied to the mobile robot 200 and the supplied power source may charge the battery. If/when charging is completed, the mobile robot 200 may be separated from the charging stand and may restart the duty (e.g., a cleaning function).

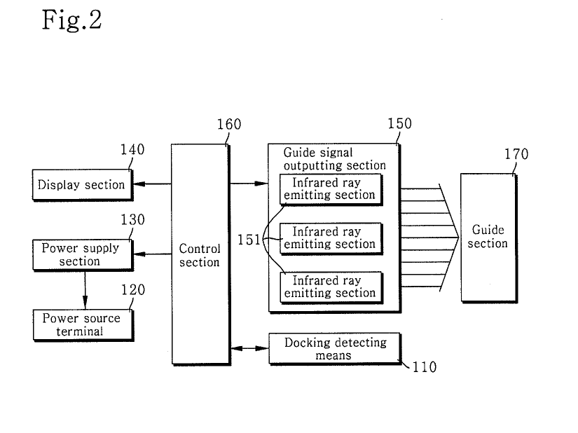

FIG. 2 is a block diagram schematically showing the charging stand according to a non-limiting embodiment of the present invention. The charging stand 100 according to the non-limiting embodiment of the present invention may be provided, for example, at a predetermined position of a section in which the mobile robot 200 performs the duty. The charging stand 100 may include a guide signal outputting section 150 including at least one infrared ray emitting section 151 formed on the front surface thereof so that the infrared ray emitting section 151 is separated to emit guide signals of different frequency widths, a guide section 170 may be formed on one side of the infrared ray emitting section 151 to regulate the proceeding direction of the infrared signal so that one side of the infrared signal output from the infrared ray emitting section 151 can be straightly proceeded in a direction vertical (i.e., a straight path with respect to the charger stand) to the charging stand 100, and a control section 160 may control the drive of the guide signal outputting section 150 if/when the mobile robot 200 is separated from the charging stand 100, in addition to a basic constitution of a charging stand.

Further, the charging stand 100 may include a docking detector 110 that detects docking of the mobile robot 200, a power source terminal 120 for charging the battery of the docked mobile robot 200, a power source supplying section 130 which converts an AC power source to a power source for driving the charging stand 100 to supply the power source. Further, the power source supplying section may convert the power source to a DC power source which may be used in the battery of the mobile robot and the power source may be supplied to a power source terminal 120, and a display section 140 displaying a charging state of the mobile robot 200 may be provided.

The guide signal outputting section 150 may be realized by at least one infrared ray emitting section 151 provided on the front surface of the charging stand 100 according to a control signal of the control section 160. The infrared ray emitting section 151 may be realized by, for example, an infrared ray emitting diode which may be configured to output a guide signal having different frequency bandwidths according to a drive instruction output from the control section 160. The output guide signal may be configured to generate at least one docking enabling region according to the frequency bandwidths.

In the non-limiting embodiment of the present invention, it is preferable to generate two regions A and C (i.e., first and second guide regions, respectively) in which only one guide signal is detected and a superposition region (e.g., a high speed return region) [i.e., region B] in which both signals (i.e., A and C) are detected, using the guide signal outputting section 150 including two infrared ray emitting sections 151.

Referring to FIG. 1, the three docking regions A, B, and C are generated by two guide signals output from the two infrared ray emitting sections 151. The three docking enabling regions A, B, and C are the two regions A and C in which only one signal is detected and the superposition region B in which two signals are detected. Accordingly, the mobile robot 200 may be configured to detect the superposition region in order to set the traveling path to the charging stand 100. Thus, the mobile robot may be docked after traveling to the charging stand 100.

According to one aspect of the present invention, the superposition region B may be generated by the guide signals transmitted from the charging stand 100 and may have a predetermined width (e.g., a width determined by the location of the guide sections). The mobile robot 200 may have a straightly proceeding property in a direction generally perpendicular to a side (e.g., front or lateral) of the charging stand 100 (e.g., extending generally straight relative to a docking location of the charger stands). If the mobile robot 200 enters into a corresponding region, it can be docked to the charging stand 100 in the shortest distance, in the shortest time, and in the optimal direction through straight traveling (or moving).

For this, the charging stand 100 according to the present invention may be formed on one side of the infrared ray emitting section 151 and may includes a guide section 170 configured to regulate the proceeding direction of the infrared ray signal so that the infrared ray signal may be outputted from the infrared ray emitting section 151. For example, the infra red ray may be emitted to one side of the guide section 170 and may be proceeded (or directed) in a direction generally perpendicular to a side of the charging stand 100 to the other side.

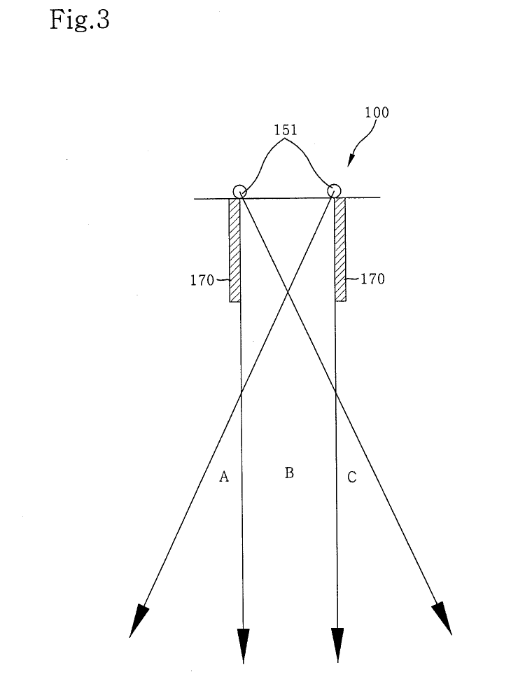

FIG. 3 is a view for schematically showing the guide section 170 which may be formed on an outer side of the charging stand according to a preferred embodiment of the present invention. However, it should be appreciated that he guide section 170 may be provided on the outer or inner side of the charging stand 100 according to the position of the infrared ray emitting section 151. Since the guide section 170 may be formed (or provided) on the front side of the infrared ray emitting 150 to regulate the emitted infrared ray signal, the guide section may protrude to the outside of the charging stand 100 in the case in which the infrared ray emitting section 151 is provided on the outer side of the charging stand 100. Further, in the case in which the infrared ray emitting section 151 is provided on the inner side of the charging stand 100, the guide section 170 may be inserted into the interior of the charging stand 100.

The guide section 170 may be formed on one side, e.g., the outer side of the infrared ray emitting section 151 to form the direction of the infrared ray signal diffused to the right and to the left thereby forming the generally straight path. The guide section 170 may be an infrared ray interrupting unit formed of a metal or a material through which infrared ray cannot be transmitted.

The guide section 170 may be provided as a generally straight path with respect to the charging stand 100 so as to have a predetermined length, so that the infrared ray signal emitted by the infrared ray emitting section 151 can maintain the straightly proceeding property. Therefore, the infrared ray signals emitted by the two infrared ray emitting sections 151 may be emitted in one direction, respectively and are may proceeded generally straight with respect to the charging stand 100 in the another direction. Therefore, as shown in FIG. 3, in the case in which guide sections 170 are formed on the outer sides of the two infrared ray emitting sections 151, both the two infrared ray signals are detected in the space between the two guide sections 170, thereby generating a region B having a predetermined width and the straight proceeding property. Further, the two regions A and C in which only one infrared ray signal is detected to the right and left sides of the superposition region B are generated by the infrared ray signal emitted on one side, thereby generating three docking enabling regions A, B, and C. If/When the mobile robot 200 enters into the superposition B, it can be effectively docked to the charging stand by straight traveling (e.g., along a straight line or path) without determining the direction in which a separate charging stand 100 is located.

The control section 160 can include a microprocessor 270 in charge of calculation, a memory 260 in which the calculation result and an operation program 260 driving the charging stand 100 are stored, and a microcontroller in which circuits such as a pulse generator providing a clock pulse for driving the microprocessor 270 are realized in a chip. The control section 160 controls the overall charging stand 100 and controls the drive of the guide signal outputting section 150 when the mobile robot 200 is separated from the charging stand 100.

The control section 160 enables the battery of the mobile robot 200 to be charged in the case in which the mobile robot 200 is docked to the charging stand 100 and outputs a control signal to the guide signal outputting section 150 so as to guide return of the mobile robot 200 when the mobile robot 200 returns to charge the battery again in the case in which the mobile robot is separated from the charging stand 100 according to a drive instruction of a user. Accordingly, the guide signal outputting section 150 may drive the infrared ray emitting section 151 and output a guide signal according to a control signal.

The mobile robot 200 may perform a duty (e.g., a cleaning function) while moving in a section determined according to the mounted program. For example, in the case of a cleaning robot, the cleaning robot 200 may be a mobile robot 200 which sucks dust and foreign substances (as well as other debris) while freely traveling in a predetermined section (e.g., an area to be cleaned).

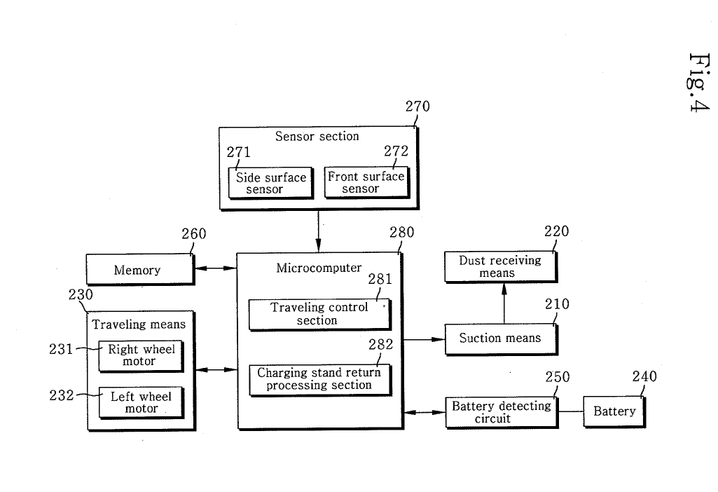

The mobile robot 200 according to a non-limiting embodiment of the present invention will be described with reference to FIG. 4.

FIG. 4 is a block diagram schematically showing a cleaning robot which is an example of the mobile robot of FIG. 1. As shown in FIG. 4, the cleaning robot 200 according to a non-limiting embodiment of the present invention may include a sensor section 270 having at least one front surface sensor 271 configured to receive and output a guide signal output from a charging stand 200. In this regard, the aforementioned sensors may be provided on a side surface of the cleaning robot 200 and at least one front surface sensor 272 provided on the front surface of the cleaning robot 200. Further, a microcomputer 280 configured to output a control signal so that the cleaning robot 200 may return to the charging stand 100 according to the guide signal detected by the sensor section 270.

Further, the cleaning robot 200 may include a dust detecting sensor which detects dust or foreign substances (or any other suitable debris) in a cleaned area, and may include a suction device (e.g., a nozzle) 210 which sucks dust and foreign substances detected by the dust detecting sensor, a dust receiver 220 which receives the dust and the foreign substances collected by the suction device 210. Further, a traveler 230 for moving (e.g., transporting etc.) the cleaning robot 200, a battery supplying a drive source to the suction device 210 and the traveler 230, a battery detecting circuit 250 configured to detect the residual amount of the battery by a predetermined period and outputting a battery charging requesting signal if/when the residual amount of the battery is below a predetermined value. Further, a memory 260 for storing a drive program of the cleaning robot 200 may be provided.

Since the suction device 210, the dust receiver 220, the battery 240, and the battery detecting circuit 250 of the cleaning robot 200 are well known, the detailed description thereof will be omitted.

The memory 260 may include a nonvolatile memory device such as an EEPROM or a flash memory and an operation program for driving the cleaning robot 200 may be stored in the memory 260. Further, according to another aspect of the present invention, frequency information of an infrared ray signal transmitted form a guide signal outputting section 150 of the charging stand 100 may also be stored in the memory. Therefore, a guide region generated by the infrared ray signal output from the charging stand 100 can be confirmed while the cleaning robot 200 is returning to the charging stand 100. Additionally, the operation program and the frequency information of the infrared ray signal may be accessed by the microcomputer 280.

The sensor section 270 may be realized by an infrared ray receiving section which may be configured to receive a guide signal such as an infrared ray signal transmitted from the charging stand 100. In this regard, the infrared ray receiving section may output the received guide signal to the microcomputer 280. According to another aspect of the present invention, the sensor section includes at least one side surface sensor 271 provided on a side surface of the cleaning robot 200 and at least one front surface sensor 272 provided on the front surface of the cleaning robot 200.

Further, a plurality of side surface sensors 271 may be provided on the outer surface of the cleaning robot 200 so as to be separated from each other. The front sensor 272 may be provided on the front surface of the cleaning robot 200 separately from the side surface sensor 271. Additionally, at least one sensor may be provided as a side surface sensor or on the front surface of the cleaning robot 200. The side surface sensor 271 and the front surface sensor 272 can be distinguished by providing the sensors with identification information.

Both the side surface sensor 271 and the front surface sensor 272 may be provided as an infrared ray receiving section configured to receive an infrared ray signal. The side surface sensor 271 may be used to determine the entry of the charging stand 100 to the docking enabling regions A, B, and C according to the guide signal outputted from the charging stand 100. The front surface sensor 272 may also be used to determine the entry of the charging stand 100 to a docking enabling region similarly to the side surface sensor 271 and may be used to maintain a straight traveling path of the cleaning robot 200 and enable the cleaning robot 200 to be docked to the charging stand 100; for example, in the case in which the cleaning robot 200 enters into a high speed return region B among the docking enabling regions, i.e. a region in which both the two infrared ray signals are detected

The traveler 230 moves (or transports, etc.) the cleaning robot 200 by driving, e.g., right and left wheel motors 231 and 232 according to a control signal output from the microcomputer 280. The right and left wheel motors 231 and 232 of the traveler 230 may be connected to right and left wheels to allow the cleaning robot 200 to travel. Therefore, the cleaning robot 200 travels to the front, rear, right, and left sides according to the rotational speeds and the rotational directions of the right and left wheel motors 231 and 232.

The microcomputer 280 includes a traveling control section controlling the overall movements of the cleaning robot 200, as well as controlling the operation of the traveler 230. Additionally, there may be provided a charging stand return processing section 282 configured to output a control signal to the traveling control section 281 so that the cleaning robot 200 can return to the charging stand 100 according to a battery charging signal output from the battery detecting circuit 250. Further, a region of the detection signal output from the charging stand according to guide signals detected by the side surface sensor 271 and the front surface sensor 272 may be detected. Also, a control signal may be outputted to the traveling control section 281 so that the cleaning robot 200 can straightly travel according to a signal detected by the front surface sensor 272 in the case in which the region of the detection signal is, e.g., a high speed return region B.

The traveling control section 281 may control traveling of the cleaning robot 200 according to a control instruction output from the operation program of the cleaning robot 200.

The charging stand return processing section 282 may be configured to receive the guide signal output through the sensor section 270 according to a battery charging request output from the battery detecting circuit 250 and may output a control signal to the traveling control section 281 so that the cleaning robot 200 may return to the charging stand 100.

If/when the battery charging request signal is provided, the charging stand return control section 282 may output a control signal to the traveling control section 281 so that the cleaning robot 200 automatically travels until the side surface sensor 271 and the front surface sensor 272 detects the guide signal output from the charging stand 100.

If/when the guide signal output from the charging stand 100 is detected by the side surface sensor 271 or the front surface sensor while the cleaning robot 200 is automatically traveling, the charging stand return processing section 282 recognizes that the cleaning robot 200 has entered into the docking enabling regions A, B, and C and determines whether the corresponding region is a return region B (e.g., a high speed return region) which is the optimal straight traveling path.

If only one guide signal is detected by the sensor section 270, the cleaning robot 200 detects the region B in which at least two guide signals are received while automatically traveling in the corresponding region. In the case in which at least two signals are detected by the side surface sensor 271 or the front surface sensor 272, i.e. the cleaning robot 200 is determined to have entered into the return region, the charging stand return processing section 282 may rotate the cleaning robot so that the front surface sensor 272 faces a direction in which the corresponding signal is transmitted and outputs a control signal to the traveling control section 281 so that the cleaning robot 200 may travel along a generally straight path to the charging stand 100. Then, the traveling control section 281 controls the cleaning robot 200 so that the cleaning robot travels along a generally straight path toward the charging stand 100 by driving the traveler 230.

Then, the charging stand return processing section 282 may output a control signal to the traveling control section 281 by continuously detecting a guide signal outputted from the front surface sensor 272 and the side surface sensor 271 so that the cleaning robot 200 does not deviate from the high speed return region B. If/when the charging stand return processing section 282 makes electrical or mechanical contact with the charging stand 100 while the cleaning robot 200 is traveling a generally straight path via the traveler 230, the cleaning robot 200 may be docked to the charging stand 100 by using a charging stand docking algorithm to charge the battery 240.

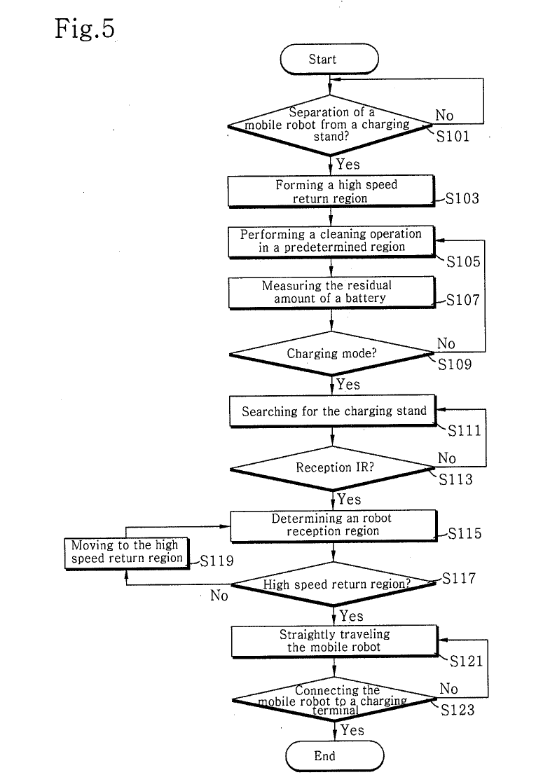

FIG. 5 is a flow chart showing a method for returning a mobile robot to a charging stand according to a non-limiting embodiment of the present invention. As shown in FIG. 5, the charging stand 100 confirms whether the mobile robot 200 deviates from the charging stand 100 to perform a given duty (S101), and if the mobile robot 200 is determined to deviate from the charging stand 100, the charging stand 100 forms the high speed return region B to easily and effectively return the mobile robot 200 via the guide signal outputting section 150 and the guide section 17 (S103).

After the mobile robot 200 deviates from the charging stand 100, it performs the cleaning operation while moving in a predetermined area by itself and periodically measures the residual amount of the battery (S105 and S107). If the measured residual amount of the battery is below a predetermined voltage, the mode of the mobile robot 200 is converted to the charging mode for charging the battery and the mobile robot 200 performs the charging stand searching operation (S109 and S111). The charging stand searching operation refers to an operation for detecting a guide signal while moving at random to detect the guide signal. If/when the guide signal (IR reception) is received while the mobile robot 200 is performing the charging stand searching operation, it is recognized that the mobile robot 200 has entered into the docking enabling regions A, B, and C and it is confirmed whether the current region is the high speed return region B (S113 and S115). In the case in which the current region is not the high speed return region B, the mobile robot 200 searches for the high speed return region while automatically traveling in the docking enabling regions. To the contrary, in the case in which the current region is the high speed return region B, after the mobile robot 200 turns the front surface sensor 272 toward the direction in which the corresponding signal is transmitted, it promptly returns to the charging stand 100 while controlling the mobile robot 200 to travel a generally straight path in the high speed region B via the traveling controlling section 282 (S117 to S121). Further, it may be confirmed whether or not the mobile robot 200 is connected to a power source terminal (a charging terminal) when the mobile robot 200 returns to the charging stand 100, and if/when a predetermined position of the mobile robot 200 is connected to the power terminal, the return operation for charging the battery may be completed and then the battery may be charged.

According to the present invention, since an optimal path region for entering into the charging stand, i.e. the return region (e.g., a high speed return region) may be generated thereby allowing the mobile robot to travel a generally straight path. Additionally, the charging stand may provide the transmission direction of the guide signal outputted from the charging stand with the straightly proceeding property through the guide section. Thus, the mobile robot may effectively returned to the charging stand in a shorter time.

It is further noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A system for docking a robot to a charger, which comprises:
a charger configured to provide a plurality of docking guide regions by outputting at least one guide signal superposed with at least one other signal to form a return region; and
a robot configured to return to the charger at a return speed by detecting the return region.

2. The system according to claim 1, wherein the plurality of docking guide regions include a first guide region where the at least one guide signal is provided, and a second guide region where the at least one other signal is provided; and
wherein the first guide region is unoccupied by the at least one other signal, and the second guide region is unoccupied by the at least one guide signal.

3. The system according to claim 2, wherein when the robot detects either one of the first and second guide regions, the robot is configured to travel a path of the detected first and second guide regions until the robot reaches the return region; and
wherein the robot is configured to return to the charger via the return region.

4. The system according to claim 1, wherein the at least one other signal is a guide signal.

5. The system according to claim 1, wherein the at least one guide signal and the at least one other signal are infrared ray signals.

6. The system according to claim 1, wherein the return region is a generally straight path having a width.

7. The system according to claim 1, wherein the robot returns to the charger by traveling a generally straight line provided in the return region.

8. The system according to claim 1, wherein the return speed is greater than a cleaning speed of the robot.

9. The system according to claim 1, wherein the charger comprises:
a guide signal outputting section having at least one infrared ray emitting section provided on the front surface of the charger and configured to emit guide signals of different frequency widths;
a guide section provided on one side of the infrared ray emitting section, wherein the guide section is configured to direct an infrared signal of the infrared ray emitting section to one side of the guide section; and
a control section that controls the charger and a drive of the guide signal outputting section when the robot is separated from the charger.

10. The system according to claim 1, wherein the robot comprises:
a sensor section having at least one side surface sensor provided on a side surface of the robot and at least one front surface sensor provided on the front surface of the robot, wherein the sensor section is configured to detect a guide signal output of the charger;
a power detecting circuit configured to detect a residual amount of a power supply of the robot, wherein the power detecting circuit is configured to output a power charging signal when the residual amount of the power supply reaches a predetermined level;
a traveler that moves the robot in a predetermined duty performing space; and
a microcomputer configured to detect the return region via the sensor section when the robot returns to the charging stand and to control movement of the traveler to return the robot to the charger at the return speed when the return region is detected.

11. A system according to claim 10, wherein the microcomputer comprises:
a traveling control section configured to control the operation of the traveler; and
a charger return processing section configured to determine a region of a detected signal output of the charger via the guide signal detected by the side surface sensor and the front surface sensor when a power charging signal output of the power detecting circuit is detected, wherein the charger return processing section is configured to provide a control signal to the traveling control section such that the robot proceeds towards the charger when front surface sensor detects the return region.

12. The system according to claim 9, wherein the guide section protrudes to an outside of the charger.

13. The system according to claim 9, wherein the guide section is formed on an inside of the charger.

14. The system according to claim 1, wherein the robot is a cleaning robot.

15. A method for docking a robot to a charger, which comprises:
outputting at least one guide signal when the robot is separated from a charger which is configured to charge the robot, and superposing the at least one guide signal with at least one other signal to provide a return region;
converting an operation mode of the robot to a discharging mode when a residual amount of a power supply is determined to be less than a predetermined amount when the mobile robot is performing an operation in a predetermined region;
detecting the return region by the robot; and
returning the robot to the charger when the return region is detected by the robot.

16. The method according to claim 15, further comprising:
providing a plurality of docking guide regions include a first guide region where the at least one guide signal is provided, and a second guide region where the at least one other signal is provided; and
providing the first guide region such that the first guide region is unoccupied by the at least one other signal, and the second guide region such that the second guide region is unoccupied by the at least one guide signal.

17. The method according to claim 16, further comprising the robot detecting either one of the first and second guide regions, the robot traveling a path of the detected first and second guide regions until the robot reaches the return region, and the robot returning to the charger via the return region.

18. The method according to claim 15, wherein the return region is provided as a generally straight path having a width.

19. The method according to claim 15, further comprising providing the at least one guide signal and the at least one other signal as infrared ray signals.

20. The method according to claim 15, further comprising providing a guide section on one side of an infrared emitting section which is configured to emit a guide signal, and directing the guide signal such that the guide signal is emitted to one side of the guide section.

21. The method according to claim 15, further comprising returning the robot to the charger along a generally straight line provided in the return region, when the return region is detected.

22. The method according to claim 15, further comprising detecting the return region by analyzing the guide signal detected by a side surface sensor provided on a side surface of the robot and a front surface sensor provided on the front surface of the robot.

23. The method according to claim 11, further comprising providing the robot as a cleaning robot.

24. The method according to claim 15, further comprising returning the robot to the charger at a return speed which is greater than a cleaning speed of the robot.
